(19) United States
(12) Patent Application Publication
(10) Pub. No.: US 2013/0254332 A1
(43) Pub. Date: Sep. 26, 2013

(54) Computer-Implemented Method and System for Supporting a User of a Medical Technology Apparatus in the Operation of the Medical Technology Apparatus

(71) Applicant: Wolfgang Stempfer, Erlangen (DE)

(72) Inventor: Wolfgang Stempfer, Erlangen (DE)

(21) Appl. No.: 13/848,658

(22) Filed: Mar. 21, 2013

(30) Foreign Application Priority Data
Mar. 22, 2012 (DE) DE 102012204641.0

(51) Int. Cl. G06F 15/16

(52) U.S. Cl. CPC H04L 67/02
USPC 709/217

(57) ABSTRACT

A computer-implemented method and an associated medical system for supporting a user of a medical technology apparatus in operation of the medical technology apparatus are provided. The method includes entering, by a user, at least one first message with an input/output unit of the medical technology apparatus. The method also includes transmitting the at least one entered first message via a communication network to a remote service center, and generating a ticket by the remote service center with reference to the at least one first message and a display on the medical technology apparatus.

This application claims the benefit of DE 10 2012 204 641.0, filed on Mar. 22, 2012, which is hereby incorporated by reference.

### BACKGROUND

The present embodiments relate to a computer-implemented method and to a medical system for supporting a user of a medical technology apparatus in operation of the medical technology apparatus with the aid of a remote service center.

Medical technology apparatuses may be state-of-the-art entities with a plurality of components and complex software. X-ray systems in the area of medical imaging applications are an example of such systems. In this area, digital imaging techniques, in which the x-ray radiation penetrating an object positioned in an examination space is detected in a spatially-resolved manner in order to generate a corresponding spatially-resolved x-ray image, are employed. With the technology of x-ray computed tomography, almost any given slice images through the object under examination may be reconstructed, and the slice images may be presented to the user.

A computed tomography scan includes, for example, an x-ray tube, x-ray detectors and a patient support couch. The x-ray tube and the x-ray detectors are disposed on a gantry that rotates during the measurement around the patient support couch or around an axis of examination running in parallel to the couch (e.g., the z-axis). The patient support couch may be moved relative to the gantry along the axis of examination. The x-ray tube generates a cone-shaped expanded x-ray bundle in a slice plane at right angles to the examination axis. The x-ray bundle penetrates a slice of an object during examinations in the slice plane (e.g., a slice of the body of a patient that is supported on the patient support couch and strikes the x-ray detectors opposite the x-ray tube). The angle at which the x-ray bundle penetrates the body slice of the patient and, if necessary, the position of the patient support couch relative to the gantry change continuously during the imaging with the computed tomography scan.

The intensity of the x-rays of the x-ray bundle that strikes the x-ray detectors after penetrating the patient is dependent on the attenuation of the x-rays by the patient. In such cases, each detector element of the x-ray detectors generates a voltage signal as a function of the intensity of the received x-ray radiation. The voltage signal corresponds to a measurement of the global transparency of the body for x-rays from the x-ray tube to the corresponding x-ray detector element. A set of voltage signals of the x-ray detectors that corresponds to the attenuation data and is recorded for a specific position of the x-ray source relative to the patient is referred to as projections. A set of projections recorded at different positions of the gantry during the rotation of the gantry around the patient is referred to as a scan. The computed tomography scan records many projections at different positions of the x-ray source relative to the body of the patient in order to reconstruct an image that corresponds to a two-dimensional slice image of the body of the patient or to a three-dimensional image. The widely used method for reconstruction of a slice image from recorded attenuation data is known as the filtered back projection method.

The connection of medical technology apparatuses, such as the computed tomography scans described above, to a remote service center with the aid of modern information technology by remote service networks is known from the prior art. Services for which deployment on site was previously necessary may thus be provided via a data link. Thus, a preventive rather than a reactive service of the medical technology apparatuses may be provided. Through proactive monitoring of the apparatuses, weak points are detected at an early stage before the weak points lead to serious errors. The availability of the medical technology apparatus increases, and downtimes are reduced. A service may be undertaken by an access to the hardware and software “remotely”. Remote service networks also support a service engineer on-site (e.g., through the provision of information).

### SUMMARY AND DESCRIPTION

Current medical technology apparatuses do not provide an opportunity for a user of the medical technology apparatus to get into contact with the remote service center easily and quickly. There is thus no rapid information path by which the user or customer may quickly exchange information with the remote service center.

The present embodiments may obviate one or more of the drawbacks or limitations in the related art. For example, a method and a system with which a user of a medical technology apparatus may exchange information quickly and securely with a remote service center are provided.

A user of a medical technology apparatus is provided with a user interface with which the user may enter messages to be transmitted to the remote service center. In the remote service center, a ticket is automatically issued for the message entered. The user of the medical apparatus receives an entry confirmation and a ticket number from a ticket system as a notification via which the inquiry is processed. The user of the medical system may enter the ticket number in the user interface in order to display a current processing status.

Tickets are issued, for example, by an issue-tracking system (e.g., a helpdesk system, a service ticket system, a ticketing system, a task tracking system, a support ticketing system, a trouble ticket system, or a processing system). This involves software (e.g., executed by hardware such as a processor) for handling receipt, confirmation, classification and processing of customer inquiries (e.g., tickets or cases). Incoming customer calls, e-mails, faxes and the like are regarded as customer inquiries. Modern issue-tracking systems may have interfaces to other systems (e.g., customer databases).

What all these systems have in common is the opportunity of allocating a ticket to a functional location or to a person within a functional location for further processing and eventually for resolution (e.g., a “closed ticket”). The ticket system provides that no message is lost, and an overview of the processes to be handled may be provided at all times.

A computer-implemented method for supporting a user of a medical technology apparatus in operation of the medical technology apparatus is provided. The method includes entry of at least one message by the user with an input/output unit (e.g., a user interface) of the medical technology apparatus. A first message entered is transmitted via a data link to a remote service center, and a ticket is generated by the remote service center with reference to the first message and to the medical technology apparatus.

One or more of the present embodiments offer the advantage of enabling the user of the medical technology apparatus to communicate with the remote service center in a simple and secure manner.

A development of the method includes transmitting at least one second message from the remote service center to the medical technology apparatus (e.g., confirmation that the inquiry has been received by returning the ticket number) and displaying the at least one second message at the input/output device. This enables the user of the medical technology apparatus to receive explicit information from the remote service center. In an efficient way, the user receives information that is of interest and importance for the work of the user.

In another embodiment, the first message may include at least one text and/or at least one command.

The second message may include at least one text and/or a least one command.

In one embodiment of the method, the second message may include information about an imminent software update. The user of the medical apparatus is informed before the distribution of the software update and may better plan execution of the software update into customer service.

In one embodiment, a medical system with at least one medical technology apparatus disposed in a medical facility (e.g., a medical operating system) is provided. The medical system includes an input/output unit of the at least one medical technology apparatus for entry of at least one first message, and a remote service center disposed at a distance from the medical facility. The medical system also includes a communication network that transmits the first message from the medical technology apparatus to the remote service center, and a ticket issuing module in the remote service center that, on arrival of the first message in the remote service center, issues a ticket with reference to the first message and to the medical technology apparatus.

In a development, the communication network may transmit at least one second message from the remote service center to the medical technology apparatus, and the input/output unit may display the second message.

In a further embodiment, the medical technology apparatus may be a computed tomograph or a magnetic resonance tomograph.

### BRIEF DESCRIPTION OF THE DRAWINGS

FIG. 1 shows a flowchart of one embodiment of a method for supporting a user of a medical technology apparatus in operation of the medical technology apparatus; and

FIG. 2 shows a block diagram of one embodiment of a system for supporting a user of a medical technology apparatus in operation of the medical technology apparatus.

### DETAILED DESCRIPTION OF THE DRAWINGS

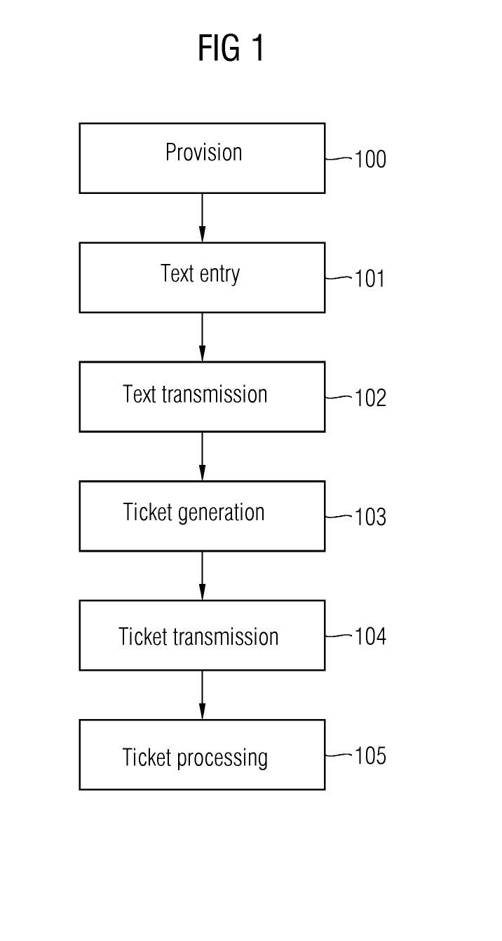

FIG. 1 shows a flowchart of one embodiment of a method for supporting a user of a medical technology apparatus in operation of the medical technology apparatus. For example, a first message is a text. In act 100, an input/output unit that is part of the medical technology apparatus is made available to the user as a user interface. In act 101, the user enters a text with the input/output unit (e.g., the text is received at the input/output unit). The text may, for example, involve a question or a fault report. In act 102, the entered text is transmitted via a communication network to a remote service center. In act 103, a ticket is generated in the remote service center. This creates a unique reference to the entered text and to the medical technology apparatus.

In act 104, the ticket number is transmitted to the medical technology apparatus and displayed at the medical technology apparatus in the user interface. In act 105, the ticket is processed.

Free texts may also be entered in the remote service center and sent to the input/output unit of the medical technology apparatus for the information of a user or of a service engineer.

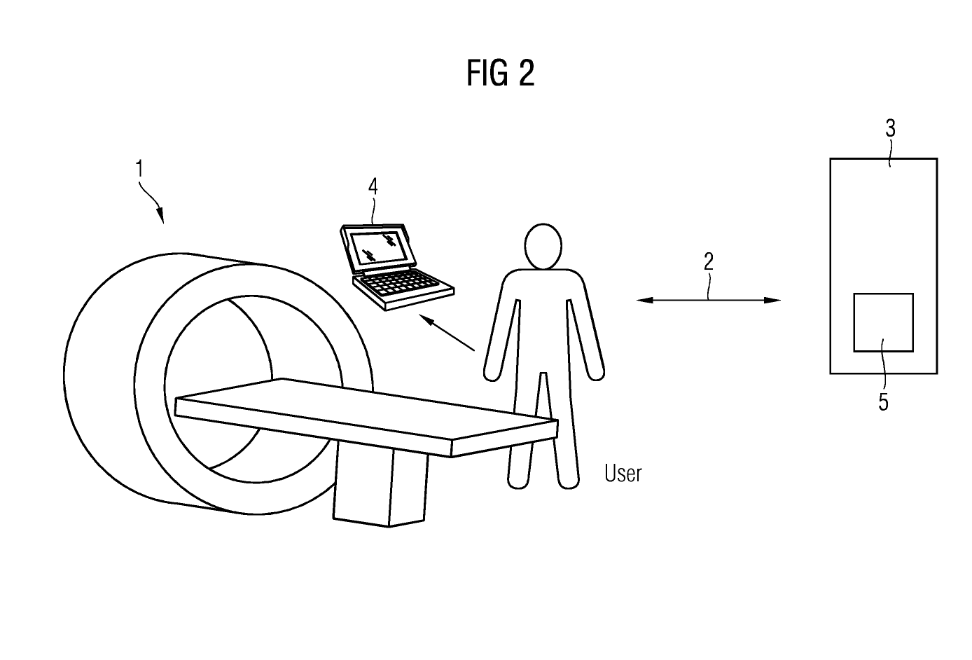

FIG. 2 shows a block diagram of one embodiment of a medical system for supporting a user of a medical technology apparatus 1 in operation of the medical technology apparatus 1. The medical technology apparatus 1 includes, for example, a computed tomograph and is connected via a communication network 2 to a remote service center 3. A ticket issuing module 5 is present in the remote service center 3. The ticket issuing module 5, in response to an inquiry from a user, issues tickets for processing the inquiry. Via an input/output unit 4 of the medical technology apparatus 1, a user of the medical technology apparatus 1 may send messages (e.g., free texts) to the remote service center 3. If such a free text is detected by the remote service center 3, the ticket issuing module 5 issues a ticket belonging to the free text and the medical technology apparatus 1. The ticket is subsequently processed by the remote service center 3 (e.g., including a processor).

Messages (e.g., information texts) may also be sent by the remote service center 3 via the communication network 2 to the medical technology apparatus 1, where the message is displayed to the user on the input/output unit 4.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A computer-implemented method for supporting a user of a medical technology apparatus in operation of the medical technology apparatus, the computer-implemented method comprising:
receiving at least one first message from the user with an input/output unit of the medical technology apparatus;
transmitting the at least one received first message via a communication network to a remote service center; and
generating, by the remote service center, a ticket with reference to the at least one received first message and the medical technology apparatus.

2. The computer-implemented method as claimed in claim 1, further comprising:
transmitting at least one second message from the remote service center to the medical technology apparatus; and
displaying the at least one second message on the input/output unit.

3. The computer-implemented method as claimed in claim 1, wherein the at least one first message comprises at least one text, at least one command, or the at least one text and the at least one command.

4. The computer-implemented method as claimed in claim 2, wherein the at least one first message comprises at least one text, at least one command, or the at least one text and the at least one command.

5. The computer-implemented method as claimed in claim 2, wherein the second message comprises at least one text, at least one command, or the at least one text and the at least one command.

6. The computer-implemented method as claimed in claim 4, wherein the second message comprises at least one text, at least one command, or the at least one text and the at least one command.

7. The computer-implemented method as claimed in claim 2, wherein the second message comprises information about a software update.

8. The computer-implemented method as claimed in claim 4, wherein the second message comprises information about a software update.

9. The computer-implemented method as claimed in claim 5, wherein the second message comprises information about a software update.

10. A medical system comprising:
at least one medical technology apparatus disposed in a medical operating system;
an input/output unit of the at least one medical technology apparatus, the input/output unit operable for entry of at least one message;
a remote service center disposed at a distance from the medical operating system;
a communication network operable to transmit the at least one message from the medical technology apparatus to the remote service center; and
a ticket issuing module of the remote service center, the ticket issuing module operable, on arrival of the at least one message in the remote service center, to issue a ticket with reference to the at least one message and to the medical technology apparatus.

11. The system as claimed in claim 10, wherein the at least one message is at least one first message,
wherein the communication network is operable to transmit at least one second message from the remote service center to the medical technology apparatus, and
wherein the input/output unit is operable to display the second message.

12. The system as claimed in claim 10, wherein the medical technology apparatus comprises a computed tomograph or a magnetic resonance tomograph.

13. The system as claimed in claim 11, wherein the medical technology apparatus comprises a computed tomograph or a magnetic resonance tomograph.

14. The system as claimed in claim 10, wherein the at least one message comprises at least one text, at least one command, or the at least one text and the at least one command.

15. The system as claimed in claim 11, wherein the at least one first message comprises at least one text, at least one command, or the at least one text and the at least one command.

16. The system as claimed in claim 12, wherein the at least one message comprises at least one text, at least one command, or the at least one text and the at least one command.

17. The system as claimed in claim 11, wherein the at least one second message comprises at least one text, at least one command, or the at least one text and the at least one command.

18. The system as claimed in claim 13, wherein the at least one second message comprises at least one text, at least one command, or the at least one text and the at least one command.

19. The system as claimed in claim 15, wherein the at least one second message comprises at least one text, at least one command, or the at least one text and the at least one command.
